(19) United States
(12) Patent Application Publication
(10) Pub. No.: US 2024/0395160 A1
(43) Pub. Date: Nov. 28, 2024

(54) Amphibious Mobile Classroom System

(71) Applicant: DAYN AMADE INVENTIONS LTD., Merseyside (GB)

(72) Inventor: Dayn AMADE, London (GB)

(21) Appl. No.: 18/685,315

(22) PCT Filed: Sep. 2, 2022
(86) PCT No.: PCT/EP2022/074494

§ 371 Date: Feb. 21, 2024

(30) Foreign Application Priority Data
Sep. 2, 2021 (GB) 2112487.0

(51) Int. Cl. G09B 5/06; B60F 3/00; G06F 3/01; G06F 3/0488

(52) U.S. Cl. CPC G09B 5/065; B60F 3/0092; G06F 3/017; G06F 3/0488

(57) ABSTRACT

The present invention provides an amphibious mobile system adapted to provide comprehensive digital learning facilities in remote areas. The system further comprises a touch screen display on the amphibious vehicle. The system further comprises a processor configured to communicate with the display and receive user input on the display. Data gathered via user inputs is compared against the metrics of emotional expression of interest gathered by the camera. The system further comprises a location sensor on the amphibious vehicle configured to determine a geographical location of the vehicle and configured to communicate the location to the processor. The processor is configured to communicate with a database before determining the type of information that is relevant to the specific location of the amphibious vehicle. The system may comprise the database. Alternatively, the system may further comprise a network communication module on the vehicle, in communication with the processor. The network communication module is configured to allow the processor to communicate wirelessly with a network device at a location that is remote from the amphibious vehicle.

### BACKGROUND

Although temporary school buildings have been employed in recent years due to a lack of funds to build permanent structures in developing countries, a shortage of classroom and learning facilities is still predominant in remote communities.

### SUMMARY

The present invention comprises a mobile classroom system, the system comprising: an amphibious vehicle; one or more touch screen displays (preferably a plurality of touch screen displays, more preferably at least four touch screen displays); a digital whiteboard; cameras on each touch screen display configured to assess the emotional responses of individual users to a user-defined event in a presentation or video: a processor configured to communicate with each touch screen display; and a location sensor on the amphibious vehicle configured to determine a geographical location of the vehicle and configured to communicate the location to the processor, wherein the processor is configured to: communicate with a database to determine information and content that is relevant to the determined location of the amphibious vehicle; and display the information using the touch screen displays.

It is an object of the present invention to provide an amphibious mobile classroom system adapted to quickly provide comprehensive digital learning facilities and learning opportunities to a relatively large number of people in rural and remote areas where school or learning facilities are not available.

According to a first aspect of the invention, the above is achieved by providing a mobile classroom system comprising: an amphibious vehicle with a container wagon adapted to functionally operate as part of a school and be moved appropriately by its own transportation means on land and on water.

The present invention provides a mobile classroom platform for rural communities, particularly those communities that are separated by bodies of water or no road infrastructure. The system comprises: an amphibious vehicle; touch screen displays and a digital whiteboard configured to communicate with the monitoring screen.

When a certain period of time has elapsed and the temporary school is no longer needed, all its learning screens and supporting waterproof sound system can easily be self-stored before relocating to a new area.

Each touch screen display is configured with a camera to determine and measure user satisfaction to the content displayed on the display screens. The processor is configured to: communicate with a database to determine information that is relevant to the audience in the determined location of the amphibious vehicle and display the most relevant content on the touch screen displays.

The present invention aims to make advances to the prior art in order to provide measurements of user satisfaction based on customised information displayed on the mobile classroom system. Advantageously, the mobile classroom system has specialised instruction equipment comprised of touch screen displays and a whiteboard which support audio and visual content.

This invention therefore provides a mobile interactive classroom to facilitate teaching and learning in remote areas. The mobile interactive classroom includes a touch screen display operable to display visual and audio lessons and later generate data associated with at least one selected metric for at least one selected individual of interest in the audience.

Preferably, the lesson content on the touch screen displays is visible from the outside of the vehicle (without the need to open up one side of the vehicle) and is equipped with a camera that receives at least one metric of emotional expression of interest from the audience.

The present invention provides a classroom-like setup that is mounted on an amphibious vehicle. The lesson content can therefore be provided directly to a community group in any geographic area.

The present invention supports audio and visual information delivery, making access to education available and more interactive to groups of people with low literacy levels. Preferably, the display comprises a fully responsive touch screen that communicates with the processor. The touch screen is preferably configured to detect user input and communicate the user input to the processor.

The interactive mobile classroom system encourages its audience to practise experiential learning by clicking on a list of possible answers to a case scenario before the correct explanation is disclosed, for example. Such interactive features enable data gathering to measure the effectiveness of the information delivered. Data gathered via user inputs is compared against the metrics of emotional expression of interest gathered by the camera.

Each touch screen display preferably comprises a fully interactive touch-sensitive screen, wherein the touch screen displays are configured to detect user input and communicate the user input to the processor.

The processor is preferably configured to receive, from a user, a selection of at least one individual of interest in the audience and a selection of at least one metric of emotional expression of interest.

The processor is preferably configured to identify frames to extract emotional expression data and use the identified frames to extract the emotional expression data. Using the identified frames to extract the emotional expression data preferably comprises extracting from the database, emotional expression data associated with at least one selected emotional metric for at least one selected user and/or individual of interest.

The digital whiteboard portion of the mobile classroom display system is equipped to display location specific information supported by a camera to capture long distance mass gesture recognition either through head gestures or hand gestures. This enables passer-by viewers or an audience to interact with the information displayed on the digital whiteboard.

Head gestures or hand gestures can be captured while the amphibious vehicle is static or in motion. Preferably the captured head gestures or hand gestures are calculated and coded to display an overall rating to specific information that was displayed on the digital whiteboard.

Advantageously, as the amphibious vehicle travels to a destination, it is optimised to display location specific information. The location specific information displayed on the digital whiteboard requires a positive or negative gesture input response from viewers.

Preferably the captured gestures and the calculated responses will form the rating of the overall positive or negative understanding/and or reaction of the audience. Each overall rating is then coded to benchmark the effectiveness of different types of information that were displayed on the digital whiteboard over a period of time.

Preferably, the mobile classroom system further comprises a power supply connected to the processor, display means and/or location sensor. The power supply comprises of solar panels mounted on its roof to supply power to the processor, display screens and/or location sensor. This allows the mobile interactive classroom to operate without the aid of conventional batteries powered by main electricity.

Advantageously, the system can therefore be run for longer in remote areas, without the need to stop and recharge the batteries.

Preferably the power supply further comprises a battery electrically connected to the solar panel for supplying power when the solar panel is not supplying power (for example in dark conditions). This allows the amphibious vehicle to operate even when the solar panel is unable to provide sufficient power for the system.

Preferably, a trailer frame of the amphibious vehicle includes a wheel assembly, and the trailer frame is removably couplable to a motor vehicle, non-motor vehicle or boat for transport.

Preferably, the system comprises a small motor that enables short distance travel (e.g. from land to water).

Preferably, the system further comprises a network communication module on the vehicle and in communication with the processor, the network communication module being configured to allow the processor to communicate wirelessly with a network device at a location that is remote from the vehicle. In other words, the vehicle has a connection to the internet and location-positioning devices.

The network communication module may be configured to communicate wirelessly using one or more of:
a satellite communication channel; a packet-switched cellular telecommunications network.

Preferably, the processor is configured to store user inputs from the touch screen and communicate the plurality of user inputs to the network device. In other words, the system gathers data from the users of the system and uploads then to an analytics server.

Preferably, the processor is configured to communicate the location of the amphibious mobile classroom system and detect contact points with water. Preferably, the predetermined data includes at least one of data indicating when the mobile classroom system is immersed or travelling in water.

In one embodiment, the database that is queried by the processor in order to determine content that is relevant to the particular location is a remote database that is queried via the network communication module. This allows the information to be updated centrally so that if there are many systems in operation it is only necessary to update the central database.

In an alternative embodiment, the system further comprises a database that is queried by the processor in order to determine content that is relevant to the particular location. In this embodiment, the content and location information is stored locally. This enables the system to display content even when an internet connection is unavailable.

Moreover, the location information may be used to determine in what language the information should be presented.

The system preferably further comprises a waterproof loudspeaker wherein the processor is configured to communicate with the waterproof loudspeaker. Advantageously, information may therefore also be provided to members of the community that are blind, partially sighted or are suffering from diseases that affect sight. Preferably, the waterproof loudspeaker system can easily be self-stored when the mobile classroom system is in transit.

The display screens may be mounted on a trailer that can towed by a motor vehicle, non-motor vehicle or boat.

The present invention also provides a system as described with reference to any of the Figures.

The following numbered clauses show further illustrative examples only:

1. A mobile classroom system, the system comprising:
an amphibious vehicle;
one or more touch screen displays;
a digital whiteboard;
cameras on each touch screen display configured to:
assess the emotional responses of individual users to a user-defined event in a presentation or video;
a processor configured to communicate with each touch screen display; and
a location sensor on the amphibious vehicle configured to determine a geographical location of the vehicle and configured to communicate the location to the processor,
wherein the processor is configured to:
   communicate with a database to determine information and content that is relevant to the determined location of the amphibious vehicle; and
   display the information using the touch screen displays.

2. The system of clause 1, wherein each touch screen display comprises a fully interactive touch-sensitive screen, wherein the touch screen displays are configured to detect user input and communicate the user input to the processor.

3. The system of clause 1 or clause 2, wherein the processor is configured to receive, from a user, a selection of at least one individual of interest in the audience and a selection of at least one metric of emotional expression of interest.

4. The system of any preceding clause, wherein the processor is configured to identify frames to extract emotional expression data and use the identified frames to extract the emotional expression data, wherein using the identified frames to extract the emotional expression data comprises:
extracting from the database, emotional expression data associated with at least one selected emotional metric for at least one selected user and/or individual of interest.

5. The system of any preceding clause, wherein the digital whiteboard portion of the mobile classroom display system is equipped to display location specific information supported by a camera to capture long distance mass gesture recognition either through head gestures or hand gestures, preferably, the head and hand gestures comprise:
captured gestures and calculated responses to rate the overall positive or negative understanding and/or reaction of the audience.

6. The system of any preceding clause, further comprising a power supply assembly comprising solar panels coupled to the roof of the amphibious vehicle.

7. The system of clause 6, wherein the power supply further comprises a battery electrically connected to the solar panel for supplying power to the processor, display and/or location sensor when the solar power is not supplying power.

8. The system of any preceding clause, wherein a trailer frame of the amphibious vehicle includes a wheel assembly, and the trailer frame is removably couplable to a motor vehicle, non-motor vehicle or boat for transport.

9. The system of any preceding clause, wherein a small self-propelled motor enables short distance travel from land to water.

10. The system of any preceding clause, wherein the system further comprises a network communication module in communication with the processor, wherein the network communication module is configured to communicate wirelessly using one or more of: a satellite communication channel; and a packet-switched cellular telecommunications network.

11. The system of any preceding clause, wherein the processor is configured to communicate the location of the amphibious mobile classroom system and detect contact points with water.

12. The system of any preceding clause, wherein the system further comprises a database that is queried by the processor in order to determine information that is relevant to the particular location.

13. The system of any preceding clause, further comprising a waterproof loudspeaker, wherein the processor is configured to communicate with the waterproof loudspeaker.

14. The system of any preceding clause wherein, in response to the emotional responses of individual users, the respective touch screen display is configured to obtain a detection result of an efficacy of the presentation or education content.

### BRIEF DESCRIPTION OF THE DRAWINGS

Specific embodiments of the present invention will now be described with reference to the following drawings in which:

FIG. 1 shows a simplified diagram of a first embodiment of a mobile classroom system with a minimum of four touch screen displays on the side of the amphibious vehicle;

FIG. 2 shows a simplified diagram of a second embodiment of a mobile classroom system with one monitoring touch screen display and one large digital whiteboard on the side of the amphibious vehicle;

FIG. 3 shows a schematic drawing of how the touch screen display and the digital whiteboard are mounted on a trailer with integrated cameras on top of each screen.

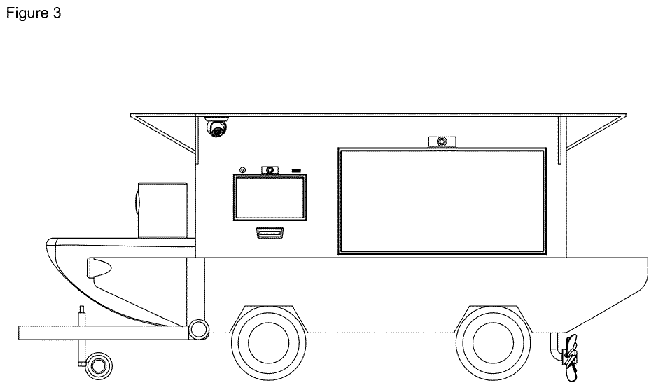

FIG. 4 shows a schematic drawing of how the touch screen displays are mounted on a trailer with integrated cameras, USB entry ports and microphones on top of each screen and some additional storage compartments underneath.

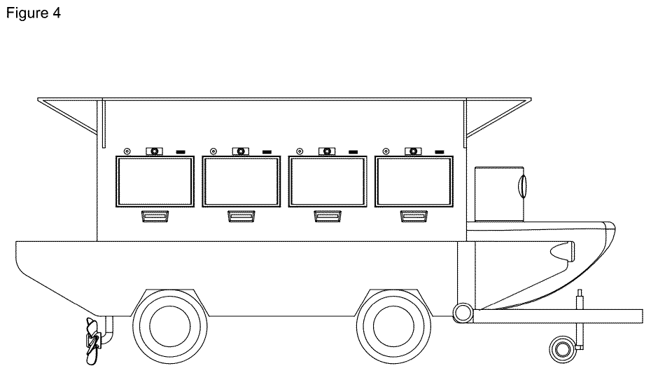

FIG. 5 shows a schematic drawing of the back of a specific embodiment.

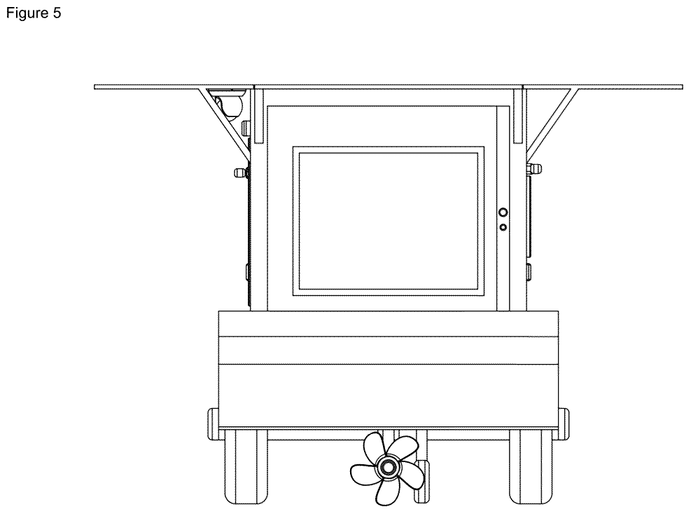

FIG. 6 shows a schematic drawing of the front of a specific embodiment.

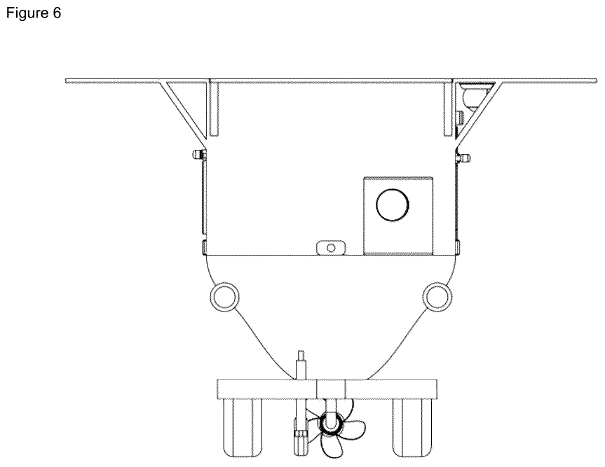

FIG. 7 shows a schematic drawing of the top of a specific embodiment.

### DETAILED DESCRIPTION OF SPECIFIC EMBODIMENTS

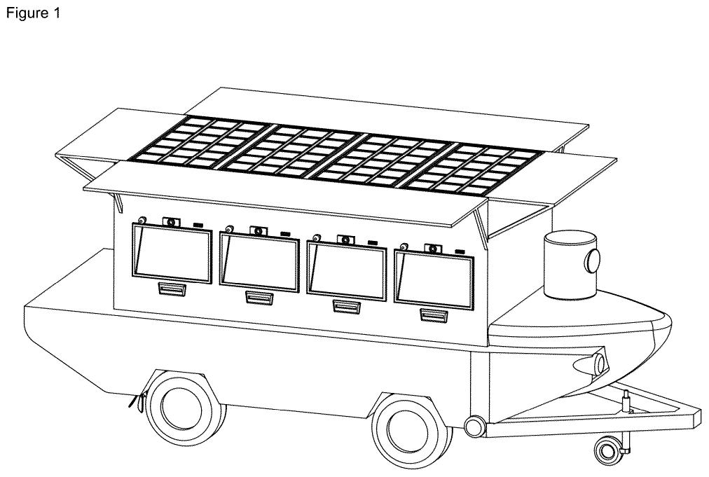

FIG. 1 shows a simplified diagram of a first embodiment of a mobile classroom with a minimum of four touch screen displays on the side of the amphibious vehicle. In this embodiment, the touch screen display is mounted on the body of the amphibious vehicle with a wireless transceiver for connecting to the internet and a location-positioning device.

The system is therefore suitable for use as a mobile classroom display. The processor of the computer may determine the display content based on the current location of the vehicle. The system is therefore operable to generate education content that is relevant to a particular community. This content is presented on the interactive displays on the body of the vehicle.

Moreover, every touch screen display is equipped with a storage compartment underneath each display screen to collect plant samples. After information is delivered (e.g. in the form of an announcement or interactive lesson), the audience will preferably be encouraged to provide further information to the system. For example, each participant may input plant samples in the storage compartments underneath the screen to record a plant that was used to treat a specific disease.

These herbal samples can be placed on a database for further research purposes and to help medical researchers manage and distribute their resources more effectively. Preferably, microdot or paint spray technology is used inside each compartment to reproduce identification for the plant samples.

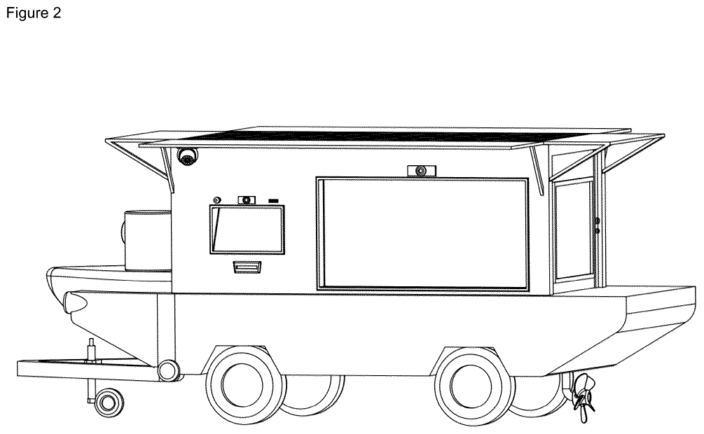

FIG. 2 shows the projection means of the second embodiment of the invention. In this embodiment, the monitoring screen is connected to one or more remote databases, each connected to a computer that determines relevant information onto the touch screens of the amphibious vehicle. A location module is also provided to determine the location of the vehicle. This may be a GPS device. There may be one location module per computer or computers may share a location module.

The interactive system may further be used to provide internet access for other educational uses. Moreover, the system may simply be used to provide access to an internet search engine and web browser. This can be useful in areas where such facilities are not usually available or not available to everyone.

The digital whiteboard can be used as a teaching screen. Online course content may thereby be wirelessly broadcasted to the digital whiteboard and students can interact with the digital whiteboard to answer and ask questions using the video camera feature. The processor of the system is preferably provided by a computer with wireless internet. The internet connection may be provided by a cellular network (for example over a 3G data connection) or a satellite link, for example.

The system is preferably powered by solar panels on the rooftop and may optionally have reserve solar panel batteries for when the solar panels are unable to provide sufficient power to the equipment. The system is therefore more environmentally friendly than systems that require power from the mains. One further benefit provided by the solar panels is that the system may be operated in areas where mains electricity is unavailable.

Alternatively, the system may run from conventional batteries that require recharging from the mains or batteries that are charged from the engine of the vehicle.

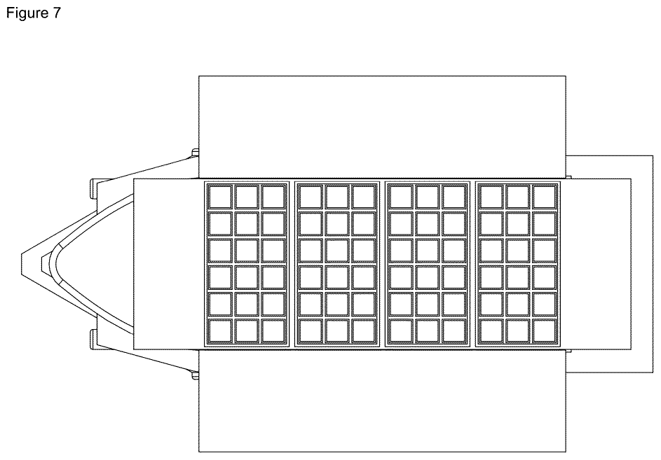

FIG. 7 shows preferable anti-scratch features of the system that protect the touch screen from harsh weather conditions and water contact. The amphibious vehicle's body is preferably made of metal and the display screen is preferably covered in acrylic to protect the screen and the other elements of the system from harsh weather conditions and water contact (for example, when the vehicle is in transit).

Moreover, when the amphibious vehicle is in transit and there is no location specific content to display, every side of the amphibious vehicle is covered with a protective storage cover. These anti-scratch features also preferably enable use of the screen in harsh weather conditions and road vandalism. Alternatively, the amphibious vehicle may open the protective cover to set up a temporary classroom.

A cooling system may also be provided in certain embodiments. This system may ensure that the electronics and power components in and on the vehicle do not overheat. The system may also be used to control the humidity levels inside the vehicle. Embodiments of the present invention described above may be usefully combined.

The present invention will be described by referring to the accompanying drawings that illustrated preferred embodiments of the invention.

1. A mobile classroom system, the system comprising:
an amphibious vehicle;
at least one touch screen display;
a digital whiteboard
at least one camera associated with the touch screen displays configured to: assess the emotional responses of individual users to a user-defined event in a presentation or video, and in response to the emotional responses of the individual users, obtaining a detection result of the efficacy of the presentation or video
a processor configured to communicate with the touch screen displays; and
a location sensor on the amphibious vehicle configured to determine a geographical location of the amphibious vehicle and configured to communicate the geographical location of the amphibious vehicle to the processor;
wherein the processor is configured to:
communicate with a database to determine information relevant the geographical location of the amphibious vehicle; and
display the information using the touch screen display.

2. The system of claim 1, wherein the touch screen display comprises a fully interactive touch-sensitive screen, wherein the touch screen display is configured to detect user input and communicate the user input to the processor.

3. The system of claim 1, further comprising: a first selection by a user of at least one individual of interest in the audience and a second selection of at least one metric of emotional expression of interest.

4. The system of claim 1, further comprising:
identified frames to extract the emotional expression data comprising:
extracting from the database, emotional expression data associated with at least one selected emotional metric for at least one selected user and/or individual of interest.

5. The system of claim 1, further comprising: a digital whiteboard portion of the mobile classroom display system equipped to display location specific information supported by a camera to capture long distance mass gesture recognition either through head gestures or hand gestures, wherein the head gestures and hand gestures comprise: captured gestures and calculated responses to rate the overall positive or negative understanding and/or reaction of the audience.

6. The system of claim 2, further comprising: a power supply assembly comprising of solar panels coupled to the roof of the amphibious vehicle.

7. The system of claim 1, further comprising: a power supply further comprises a battery electrically connected to a solar panel for supplying power to the processor, display and/or location sensor when the solar power is not supplying power.

8. The system of claim 1, further comprising a trailer frame including a wheel assembly, wherein the trailer frame is removably coupled to a motor vehicle, non-motor vehicle, or boat for transport.

9. The system of claim 1, further comprising a small self-propelled motor that enables short distance travel from land to water.

10. The system of claim 1, further comprising a network communication module configured to communicate wirelessly using one or more of: a satellite communication channel; and a packet-switched cellular telecommunications network.

11. The system of claim 1, wherein the processor is configured to detect contact points with water.

12. The system of claim 8, further comprising predetermined data that includes at least one of data indicating when the mobile classroom system is immersed or travelling in water.

13. The system of claim 1, wherein further comprising a database that is queried by the processor in order to determine information that is relevant to a particular location.

14. The system of claim 1, further comprising a waterproof loudspeaker, wherein the processor is configured to communicate with the waterproof loudspeaker, and wherein the waterproof loudspeaker system may be self-stored when the amphibious vehicle is in transit.

15-16. (canceled)
